(19) United States
(12) Patent Application Publication
(10) Pub. No.: US 2009/0094012 A1
(43) Pub. Date: Apr. 9, 2009

(54) METHODS AND SYSTEMS FOR GRAND CANONICAL COMPETITIVE SIMULATION OF MOLECULAR FRAGMENTS

(75) Inventor: Matthew Clark, Wayne, PA (US)

Correspondence Address: PEPPER HAMILTON LLP, ONE MELLON CENTER, 50TH FLOOR, 500 GRANT STREET, PITTSBURGH, PA, 15219, US

(73) Assignee: LOCUS PHARMACEUTICALS, INC., Blue Bell, PA (US)

(21) Appl. No.: 11/869,075

(22) Filed: Oct. 9, 2007

(51) Int. Cl. G06G 7/48

(52) U.S. Cl. 703/11

(57) ABSTRACT

Methods and systems for analyzing a macromolecule for potential binding sites are disclosed. Multiple molecular species and a free energy value may be selected. An operation for a molecular fragment of one of the molecular species may be selected from insertion, deletion and movement operations. The selected operation may be performed on a computer representation of an instance of a molecular fragment at one of a plurality of binding sites based on a grand canonical ensemble probability density function associated with the selected operation. Information may be stored pertaining to the plurality of binding sites. The operation selecting, performing and information storing operations may be performed multiple times. Multiple occupation probabilities may be provided based on the stored information. The occupation probabilities may include, for each molecular species, a probability that an instance of a molecular fragment of the molecular species resides at a binding site.

### BACKGROUND

The present disclosure generally relates to methods of identifying binding sites on proteins, methods for identifying classes of compounds suitable for binding with a protein and methods for determining more strongly binding compounds for particular binding sites.

Determinations of protein structures have previously been conducted by isolating crystals of a protein of interest and analyzing structures using X-ray crystallography. Typically, the protein has been co-crystallized with a heavy metal components or subjected to multiple co-crystallizations, with the heavy metal providing a reference for solving the crystallographic data.

With a determination of the structure of a protein, or the structure of another macromolecule having significant tertiary structure, such as DNA or RNA, binding sites can be identified that might be significant to a biological process such as an enzyme active site or a site for interacting with another macromolecule or with itself. Computational efforts have focused on sampling the surface of a molecule to find good fits with known binding agents. Such methods are dependent on knowledge of the structure of good binding agents and the function of the protein.

A more traditional approach has sought to co-crystallize binding substances with the macromolecule to identify binding sites. With the binding site identified, an educated guess can be made to new molecules that could bind to the site. Such educated guesses can guide synthetic methods, including combinatorial chemistry methods, to make and test new molecules.

When such prospective binding agents are effective, the structural correlations drawn from the results can be tied to information about the binding site to make still further inferences about the structure important to a biological function. This co-crystallization approach depends on an initial knowledge of active agents and is experimentally difficult and time consuming.

Another method of identifying binding sites for molecules from a three-dimensional structural solution of a macromolecule is disclosed in U.S. Pat. No. 6,735,530 to Guarnieri, which is incorporated herein by reference in its entirety. The structural solution for the macromolecule can be derived from crystallography, spectroscopic analyses such as Nuclear Magnetic Resonance (NMR), computational derivations or any other method of determining such structures. The method can narrow the number of potential binding sites and identify the organic fragments that effectively interact with the binding site(s). The data obtained for the organic fragments can further identify the orientations of the fragments useful in a candidate. Binding sites can be ranked according for a particular fragment based on the generated data. Accordingly, sites having the potential to more strongly bind a fragment can be quantitatively determined.

For free energy computations, the role of a solvent may be considered. For example, in a biological setting for drug design, the role of a solvent is particularly relevant. The entropy and enthalpy for creating a cavity in the solvent, filling it with a ligand, and re-ordering the solvent about the ligand has been explored experimentally and theoretically.

Typically, simulations use either a continuum solvent approach or an explicit water model. Continuum solvent approaches compute the effect of a generic bath of water. This can improve results, but does not provide insight into specific water interactions in the binding site.

Explicit water models whether modeled as populated periodic boxes or droplet models, bathe protein in bulk water. The bulk water does not permit the ligand to freely move about different poses and conformations. As such, sampling is inhibited.

Experimentally separating out the solvent effect from observed binding constants can be difficult. Accordingly, directly calibrating computed energies is challenging. Binding measurements only provide the sum of all effects (i.e., the total binding free energy). The total possible number of individual microstates in a liquid state simulation can be quite large. Thus several approximations have been developed to reduce the complexity of the computations.

One common approximation to compute free energy is the molecular mechanics/Poisson-Boltzmann solvent-accessible surface area (MM/PBSA) method. This method combines an enthalpy value from molecular mechanics and a computed salvation free energy together with a Poisson-Boltzmann electric potential and a solvent-accessible surface area energy term. While this solvation treatment addresses the potential of displacing solvent and estimates the entropy of solvent displacement and reorganization, it does not account for the entropy change of the ligand or protein on binding.

Such computations can be improved by integrating the energies over an ensemble of poses near the binding pose of interest. The mining minima algorithm and related algorithms perform such integration to improve the ability to score the entropy of a particular binding site. Sites that allow more freedom of movement at similar binding energies may have better binding than those that have less freedom of movement.

The free energy perturbation methods carry out a more complete sampling of states and allow a molecule to gradually grow into, or be removed from, a binding pocket in order to integrate the energy required for the change. In principle, these methods are statistically better than the PBSA or minima-based methods because the algorithms are more rigorously derived from classical statistical mechanics. However, computational issues may result from free energy perturbation methods because these methods are more complex. A significant issue results from the fact that the ligand has a tendency to leave the vicinity of the protein as the ligand potential is decreased in the integration cycle. The use of complex constraints and associated methods to remove the thermodynamic effects of the constraints have been developed to attempt to address this problem.

The main limitation of the free energy perturbation methods is that they carry out free energy computations for a pre-selected pose in a pre-selected binding site of the protein. While the dynamics-based sampling regimen allows the ligand to move about within the energy barriers defined by the simulation temperature, the ligand cannot cross these barriers to explore different poses. The possible conformations to explore increase dramatically with the number of rotatable bonds in the molecule. Accordingly, fully sampling the conformations of a flexible molecule is very computationally intensive.

### SUMMARY

Before the present systems, devices and methods are described, it is to be understood that this disclosure is not limited to the particular systems, devices and methods described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “molecular fragment” is a reference to one or more molecular fragments and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention. As used herein, the term “comprising” means “including, but not limited to.”

In an embodiment, a computer-implemented method of analyzing a macromolecule for potential binding sites may include selecting a plurality of molecular species, selecting a free energy value, selecting an operation from a molecular fragment insertion operation, a molecular fragment deletion operation and a molecular fragment movement operation, performing the selected operation on a computer representation of an instance of a molecular fragment at one of a plurality of binding sites based on a grand canionical ensemble probability density function associated with the selected operation, determining whether to store information pertaining to the plurality of binding sites, repeating the operation selecting, performing and determining steps a plurality of times, and outputting a plurality of occupation probabilities based on the stored information. The occupation probabilities may include, for each molecular species, a probability that an instance of a molecular fragment of the molecular species resides at a binding site.

In an embodiment, a system for analyzing a macromolecule for potential binding sites may include a processor, and a processor-readable storage medium in communication with the processor. The processor-readable storage medium may include one or more programming instructions for performing a method of analyzing a macromolecule for potential binding sites. The method may include selecting a plurality of molecular species, selecting a free energy value, selecting an operation from a molecular fragment insertion operation, a molecular fragment deletion operation and a molecular fragment movement operation performing the selected operation on a computer representation of an instance of a molecular fragment at one of a plurality of binding sites based on a grand canonical ensemble probability density function associated with the selected operation determining whether to store information pertaining to the plurality of binding sites, repeating the operation selecting, performing and determining steps a plurality of times, and outputting a plurality of occupation probabilities based on the stored information. The occupation probabilities may include, for each molecular species, a probability that an instance of a molecular fragment of the molecular species resides at a binding site

In an embodiment, a method of analyzing a macromolecule for potential binding sites may include selecting an operation from a plurality of operations, performing the operation on a computer representation of an instance of a molecular fragment of a molecular species at a binding site with a probability based on an associated grand canonical ensemble probability density function, repeating the selecting and performing steps a plurality of times for instances of molecular fragments of a plurality of molecular species at a plurality of binding sites, and storing, in a storage medium at least one occupancy probability pertaining at least to a likelihood that an instance of a molecular fragment of a molecular species resides at a binding site.

### DESCRIPTION OF THE DRAWINGS

Aspects, features, benefits and advantages of the present invention will be apparent with regard to the following description and accompanying drawings, of which:

FIG. 1 depicts a flow diagram for an exemplary method of competitively simulating molecular fragments from a plurality of molecular species to determine binding sites on or near a macromolecule according to an embodiment.

FIG. 2 depicts a flow diagram for an exemplary method of determining whether to insert a molecular fragment at a sampling site of a macromolecule according to an embodiment.

FIG. 3 depicts a flow diagram for an exemplary method of determining whether to remove a molecular fragment from a sampling site of a macromolecule according to an embodiment.

FIG. 4 depicts a flow diagram for an exemplary method of determining whether to reposition a molecular fragment at a sampling site of a macromolecule according to an embodiment.

FIG. 5 is a block diagram of an exemplary system that may be used to contain or implement the program instructions according to an embodiment.

### DETAILED DESCRIPTION

The following terms shall have, for the purposes of this application, the respective meanings set forth below.

A “macromolecule” refers to a molecule or collection of molecules. Thus, although the term typically refers to proteins, ribonucleic acids, structures formed of both nucleic acid and protein, carbohydrates, structures formed of two or more of the aforementioned, and the like, it can also refer to structures formed with any other molecule or molecules including lipids. Macromolecules are used in the method described herein with reference to maps of their tertiary structure. Such maps are typically generated by X-ray diffraction studies, which have generated maps for thousands of macromolecules. However, maps can be produced by other methods such as computational methods or computational methods supplemented by other data such as NMR data.

“Organic fragments” or “ORFs” are molecules that can be used to model one or more modes of interaction with a macromolecule, such as the interactions of carbonyls, hydroxyls, amides, hydrocarbons and the like.

A “molecular fragment” is a molecule selected from one of a plurality of molecular species defined for a particular simulation. Exemplary molecular fragments may include ORFs and/or water.

A “sampling site” is a molecular binding site for a macromolecule at which a molecular fragment of a particular molecular species can, as a practical matter, reside. Sampling sites are determined by defining a volume that contains the protein in Cartesian space and randomly selecting points within the volume. The selection of points may be biased to be close to the protein to specified regions within the volume. The probability of accepting a particular sampling site may be adjusted based on this bias.

In an embodiment, a grand canonical ensemble simulation may be performed utilizing a Monte Carlo algorithm. A Monte Carlo algorithm is a numerical computational algorithm that simulates the behavior of a physical system, such as a molecular model. Monte Carlo algorithms are stochastic in that they depend upon the use of random (or pseudorandom) numbers. In particular, the Monte Carlo algorithm used in the simulations described herein may determine whether a molecular fragment is inserted, deleted or moved. The probability of selecting an insertion, deletion or modification of a selected fragment may be based on the free energy of the molecular fragment.

Simulation of molecular fragments using the grand canonical ensemble has several characteristics beneficial to free energy calculations. One benefit is that the number of parameters that need to be assumed when simulating a system may be very small. As such, the outcome of such simulations may be deterministic. The primary variables of interest are the free energy levels at which to carry out the simulation, the number of steps of equilibration, and the number of snapshots taken for sampling the resulting poses. Equilibration may be dynamically based on equilibration of population and/or energy.

Moreover, the simulation is free from assumptions about the starting pose or nature of binding site. Free energy perturbation methods may compute the binding free energy of a pre-selected pose. In contrast, the grand canonical ensemble simulation samples and computes the free energy of molecular fragments without any assumptions other than proximity to the macromolecule. This makes the method well adapted to locating novel binding sites and poses. In addition, the accuracy of the free energy computation is increased because the sampling includes the entire protein and a large number of configurations as compared to perturbation calculations on a limited number of poses. A single simulation provides the data to determine the binding free energies of any pose near the surface of the macromolecule.

In addition, the binding free energies are a direct outcome of the simulation, and little processing is required to determine the free energies. Once the chemical potential for the simulation is assigned, the ensemble of poses generated by the Monte Carlo Markov chain is for the free energy that the chemical potential represents. No other integration methods are necessary to extract the free energy of the molecular fragments. For a particular binding mode, the free energy is determined by observing the chemical potential at which the binding mode no longer appears. The lowest chemical potential at which the binding mode was populated is taken as the free energy of that mode.

While previous simulation models have computed binding of water and organic fragments separately and then excluded the organic fragments from binding to positions that show a high affinity for water, the present systems and methods compute binding of each of one or more organic fragments concurrently with the binding of water. By allowing water to interact with itself, with the macromolecule, and with the organic fragments simultaneously, a very close approximation of a true solvent environment in the macromolecule binding site may result.

A Monte Carlo simulation for a system with a variety of different molecular species may be performed. The simulation may include tracking a separate N, a number of ORFs or water molecules, for each molecular species. Each Monte Carlo step may operate on a single molecular fragment of a selected molecular species.

More specifically, grand canonical ensemble simulations may include a changing number of molecular fragments (ORFs or water) of each molecular species in the system during the simulation. In other words, the sampling is not restricted to the configuration space of a given dimension. Rather, it has been extended to a set of configuration spaces. The change in the number of molecular fragments of each molecular species may correspond to the fact that the grand canonical partition function Ξ is the linear combination of the corresponding canonical partition functions of a different number, N, of molecular fragments, Q:

$$Ξ ( T , V , μ ) = {\sum }_{N = 1}^{∞} \frac{exp ( μ N / kT )}{N !} Q ( T , V , N ) , \qquad ( 1 )$$

where T is the absolute temperature, μ is the chemical potential, k is the Boltzmann constant and

Q(T, V, N)=q^{N}∫exp(−E(X^{N})/kT)dX^{N} (2)

with q being the molecular partition function.

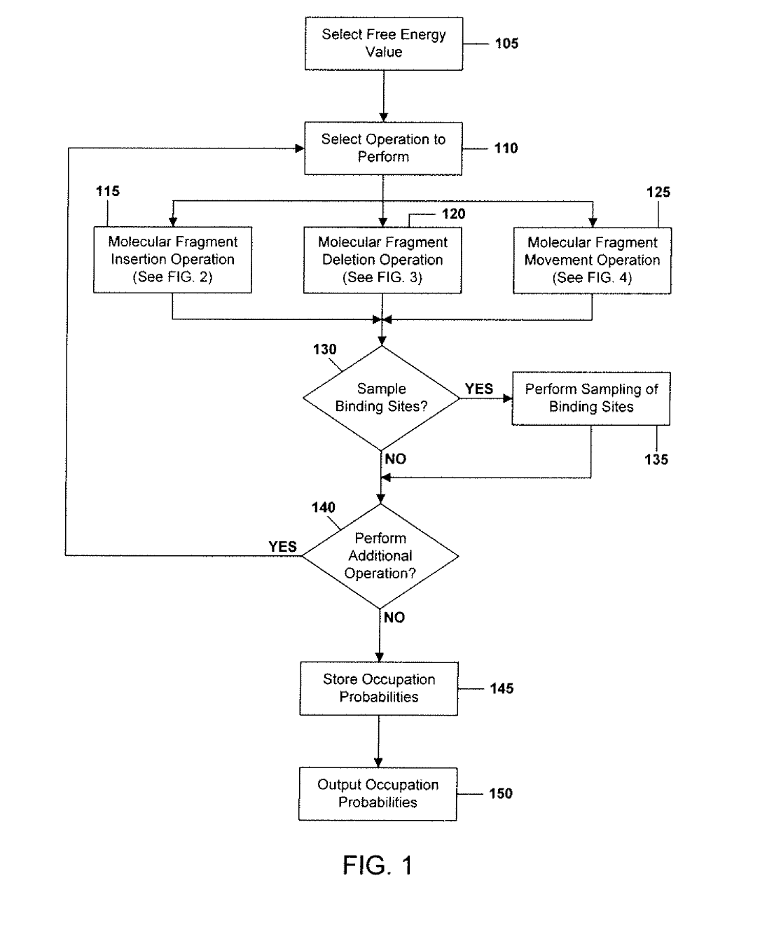

In each step of a simulation at a particular free energy value, the simulation may competitively simulate molecular fragments from a plurality of molecular species to determine binding sites for the molecular fragments using grand canonical ensemble probability density functions. An exemplary flow diagram for such a method is depicted in FIG. 1.

As shown in FIG. 1, a free energy value may be selected 105. In the grand canonical ensemble, the free energy is commonly specified as the excess chemical potential relative to the chemical potential of a reference state, μ′=μ−μ_{ideal}. Alternately, the free energy may be represented as the unitless property B defined by the excess chemical potential, Boltzmann's constant, k, the temperature, T, and the average number of molecular fragments in the system for the selected molecular species, <N>, as

$$B = \frac{{μ}^{′}}{kT} + ln ( < N > ) . \qquad ( 3 )$$

Because B is related to the concentration of molecular fragments in the system, as shown below, B, rather than the chemical potential, may be annealed.

One feature of the grand canonical ensemble is that the number of molecular fragments in a system varies over time as molecular fragments are inserted and deleted. The number of molecular fragments varies until the system density equilibrates to the selected chemical potential. The probability of accepting an insertion of a molecular fragment into the systems, and thus transitioning from state i to j, in terms of B, is

$$\text{?} = \frac{V exp ( B - ( \text{?} ) / kT )}{{N}_{j}} . \\ \text{?} \text{indicates text missing or illegible when filed} \qquad ( 4 )$$

This equation can be factored to emphasize the relation of B to the system concentration as

$$\text{?} = exp ( B ) \frac{V}{{N}_{j}} exp ( - Δ E / kT ) . \\ \text{?} \text{indicates text missing or illegible when filed} \qquad ( 5 )$$

For an ideal gas, ΔE is always zero. At B=0, the system results in a system concentration of 1 molecular fragment per system volume (V). The reference state for the free energy at B=0 is therefore determined by multiplying

$$\frac{V}{\text{?}}$$

$$\text{?} \text{indicates text missing or illegible when filed}$$

by a reference concentration to make the unitless value B represents energy with respect to this reference state.

A plurality of simulations may be performed. Each simulation may be performed at a selected free energy value. As the excess chemical potential decreases, retention of a fragment at a given sampling site indicates a high relative binding affinity. In an embodiment, the schedule of simulations may be conducted at a plurality of B values ranging from, for example and without limitation, about 10 to about −25. Other values of B may also be used within the scope of this disclosure.

For a simulation, a plurality of steps may be performed. In a particular step, the simulation may select 110 an operation to perform. For example, the simulation may select 110 between, for example, a molecular fragment insertion operation 115 a molecular fragment deletion operation 120 or a molecular fragment movement operation 125. An operation may be selected 110 randomly, pseudorandomly or based on a sequential order. Alternately, operation selection may be weighted based on a weighting value assigned to each operation. For example, a molecular fragment insertion operation 115 may be selected 110 with a 70% probability; a molecular fragment deletion operation 120 may be selected with a 25% probability; and a molecular fragment movement operation 125 may be selected with a 5% probability. In an embodiment, two or more operations may have equal or substantially equal probabilities of being selected 110. Other methods of selecting 110 an operation may also be performed within the scope of this disclosure.

Selection of a particular operation does not require that a molecular fragment actually be, for example, inserted, deleted or moved. Rather, the simulation may perform the selected operation probabilistically based on a probability function defined for the particular operation. The embodiments disclosed below describe probability functions based on B for various operations. However, alternate free energy measures, such as the excess chemical potential may be used to determine different probability functions for such operations within the scope of this disclosure.

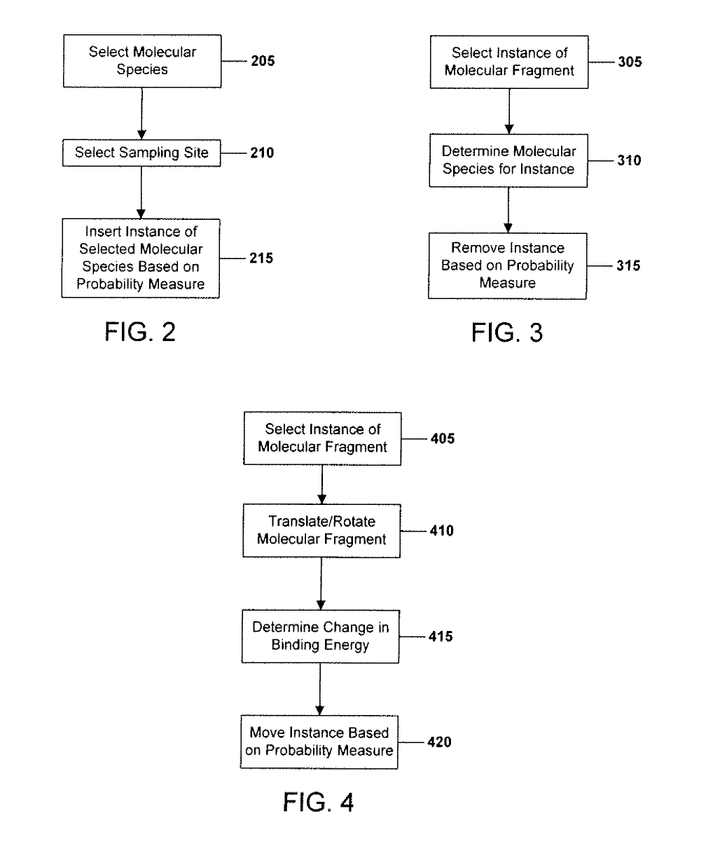

FIG. 2 depicts a flow diagram for an exemplary method of determining whether to insert a molecular fragment at a sampling site of a macromolecule according to an embodiment. If a molecular fragment insertion operation 115 is selected 110, a molecular species may be selected 205 from a plurality of molecular species. In an embodiment, the plurality of molecular species may include one or more ORFs and/or water. The molecular species may be selected 205 from the plurality of molecular species based on a random selection process, a pseudorandom selection process or a process using a weighting factor for each molecular species.

The types of ORFs considered may be representative of chemical features that have proven useful in the design of pharmaceuticals or other bioactive chemicals. Examples of useful ORFs may include, without limitation, those displayed in Table 1.

TABLE 1

| Name | Structure |
|---|---|
| acetone | Error! Not a |
| | valid |
| | embedded |
| | object. |
| acetaldehyde | Error! Not a |
| | valid |
| | embedded |
| | object. |
| formamide | Error! Not a |
| | valid |
| | embedded |
| | object. |
| ammonia | NH₃ |
| benzene | Error! Not a |
| | valid |
| | embedded |
| | object. |
| acetic acid | Error! Not a |
| | valid |
| | embedded |
| | object. |
| pyrazine | Error! Not a |
| | valid |
| | embedded |
| | object. |
| methyl acetate | Error! Not a |
| | valid |
| | embedded |
| | object. |
| dimethyl ether | Error! Not a |
| | valid |
| | embedded |
| | object. |
| formaldehyde | Error! Not a |
| | valid |
| | embedded |
| | object. |
| furan | Error! Not a |
| | valid |
| | embedded |
| | object. |
| imidazole | Error! Not a |
| | valid |
| | embedded |
| | object. |
| methane | CH₄ |
| methanol | Error! Not a |
| | valid |
| | embedded |
| | object. |
| phosphoric acid | Error! Not a |
| | valid |
| | embedded |
| | object. |
| pyridine | Error! Not a |
| | valid |
| | embedded |
| | object. |
| pyrimidine | Error! Not a |
| | valid |
| | embedded |
| | object. |
| pyrrole | Error! Not a |
| | valid |
| | embedded |
| | object. |
| methanethiol | Error! Not a |
| | valid |
| | embedded |
| | object. |
| thiophene | Error! Not a |
| | valid |
| | embedded |
| | object. |

A sampling site may be selected 210 randomly from the volume in Cartesian space containing the protein. As stated above, sampling sites may be determined by identifying one or more binding sites for the macromolecule that can receive the selected molecular fragment having the selected molecular species. In an embodiment, the sampling site may be randomly (including pseudorandomly) selected 210 from the sampling sites for the selected molecular species. In an embodiment, sampling sites may be assigned weighted values and selected 210 based on the assigned weighted values. For example, and without limitation, if a first sampling site were assigned a weighted value of 1 and a second sampling site were assigned a weighted value of 2, the first sampling site and the second sampling site may be selected 210 with probability 1/3 and 2/3, respectively.

An instance of a computer representation of a molecular fragment having the selected molecular species may be inserted 215 at the selected sampling site with a determined probability. In an embodiment, the determined probability for inserting the molecular fragment may be based on the value of B and a change in the binding energy that results from insertion of the molecular fragment at the sampling site, ΔE. For example, an attempt to insert a molecular fragment at a sampling site may be accepted based on a grand canonical ensemble probability density function with the following probability:

$$\text{?} = min ( 1 , exp ( - Δ E / kT + B ) \frac{V}{N + 1} ) , \\ \text{?} \text{indicates text missing or illegible when filed} \qquad ( 6 )$$

where N is the number of molecular fragments of the selected type, and V is the volume of the Cartesian space (which is constant during the simulation).

Here, the effect of the chemical potential may be introduced into the acceptance expression via the B parameter. The presence of the V and N factors may follow from the relation between the canonical and grand canonical partition functions (see equation1)). The V and N factors may also be given a probabilistic interpretation, where the insertion site may be chosen with probability 1/V and the molecular fragment to be inserted may be chosen with probability 1/N.

At each step, the algorithm may model the insertion 215 of the selected fragment. The probability of the insertion 215 may then be determined from the grand canonical ensemble probability density function, and the selected molecular fragment may be represented as resident at the site by a random number generating protocol weighted to the probability value. Alternative methods for choosing to make this representation, such as applying cutoff values that determine whether or not to represent the insertion 215, may also be applied.

FIG. 3 depicts a flow diagram for an exemplary method of determining whether to remove a molecular fragment from a sampling site of a macromolecule according to an embodiment. If a molecular fragment deletion operation 120 is selected 110, an instance of a computer representation of a molecular fragment at a sampling site of a macromolecule may be selected 305. In an embodiment, the instance of the molecular fragment may be randomly (including pseudorandomly) selected 305 from instances of molecular fragments at sampling sites. In an embodiment, the instance of the molecular fragment may be selected 305 based on a weighting factor applied to at least one instance.

Once an instance of a molecular fragment is selected 305, a molecular species for the selected instance may be determined 310 from a plurality of molecular species. In an embodiment, the plurality of molecular species may include one or more ORFs and water. The types of ORFs for a particular simulation may be representative of chemical features that have proven useful in the design of pharmaceuticals or other bioactive chemicals. Examples of useful ORFs may include, without limitation, those displayed in Table 1 above.

The instance of the molecular fragment may be removed 315 from the selected sampling site of the macromolecule with a determined probability. The determined probability for removing 315 the instance of the molecular fragment may be based on the value of B and a change in the binding energy that results from removal of the molecular fragment from the sampling site, ΔE. For example, an attempt to remove 315 a molecular fragment from a sampling site may be accepted based on a grand canonical ensemble probability density function with the following probability:

$$\text{?} = min ( 1 , exp ( - Δ E / kT - B ) \frac{N}{V} ) . \\ \text{?} \text{indicates text missing or illegible when filed} \qquad ( 7 )$$

FIG. 4 depicts a flow diagram for an exemplary method of determining whether to reposition a molecular fragment at a sampling site of a macromolecule according to an embodiment. If a molecular fragment movement operation 125 is selected 110, an instance of a computer representation of a molecular fragment at a sampling site of a macromolecule may be selected 405. In an embodiment, the instance of the molecular fragment may be randomly (including pseudorandomly) selected 405 from instances of molecular fragments at sampling sites. In an embodiment, the instance of the molecular fragment may be selected 405 based on a weighting factor applied to at least one instance.

Once an instance of a molecular fragment is selected 405, the molecular fragment may be moved 410. In an embodiment, the molecular fragment may be translated 410. In an embodiment, the molecular fragment may be rotated 410. In an embodiment, the amount by which the molecular fragment is moved 410 may be determined according to a random or pseudorandom algorithm. In an embodiment, a force bias canonical probability density function may be used to translate and/or rotate 410 the molecular fragment by a small amount (e.g., up to ±0.2 Å,±30°) so that the molecule transitions and/or rotations are biased to relieve any forces created by interaction with the macromolecule.

A change in binding energy may be determined 415 based on the movement of the molecular fragment. A determination as to whether to accept or reject the resulting pose may be made 420 based on the change in energy, ΔE, as a result of the change attempted. Accordingly, an attempt to move 410 a molecular fragment from a sampling site may be accepted based on a grand canonical ensemble probability density function with the following probability:

Pₘₒᵥₑ^{acc}=min(1, exp(−ΔME/kT)). (8)

Such position shifting may be thought of as effecting a “shaking” of the molecular fragment to identify its favored positioning. When this shaking is applied, the outcome of a simulation may reflect higher probability orientations. It should be noted that the temperature (which is kept constant during the simulation) enters the acceptance formula as a scaling factor of the energy change.

Referring back to FIG. 1, after an operation is completed, a determination may be made 130 as to whether to perform an unbiased sampling at each sampling site after equilibrium is achieved. In an embodiment, a plurality of operations, such as about 2×10⁶ operations, may be performed for a simulation. Of these operations, the majority, such as approximately 1.5×10⁶ operations, may be used to equilibrate the simulation so that the number of molecular fragments for each molecular species is substantially constant during the course of the simulation. For example, after equilibrium is achieved, an unbiased sampling may be performed 135 after every 20000 operations are attempted. An occupation probability of a molecular fragment at a binding site may be determined based on these samplings.

A determination may be made 140 as to whether to perform an additional operation for the simulation. If another operation is to be performed, the process may return to 110 above.

Upon completion of the simulation, information pertaining to one or more occupation probabilities for molecular species at one or more binding sites may be stored 145. An occupation probability for a molecular species at a binding site is the likelihood that a molecular fragment of a particular molecular species resides at the binding site. The occupation probability may be determined by determining the ratio of the number of samples for which an instance of a molecular fragment is located at the binding site to the total number of samples The information pertaining to the occupation probabilities may include information describing the binding sites at which molecular fragments for at least one molecular species are located, the occupation probabilities for the molecular fragments for the at least one molecular species, the orientation and position of the molecular fragments at the binding sites, and the like. The list may be stored 145 in a processor-readable storage medium. In an embodiment, the list or a portion thereof may be provided or otherwise outputted 150 to a user in a printed form, via a display, in an electronic or physical media, or the like.

The potential energy, E, described above may be computed using the AMBER molecular mechanics force field, which is known to those of ordinary skill in the art. The AMBER force field is comprised of a two-part non-bonded interaction including the Lennard-Jones dispersion potential and an electrostatic potential:

$$E = 4 ɛ ( \text{?} ) + \text{?} , \\ \text{?} \text{indicates text missing or illegible when filed} \qquad ( 9 )$$

where rᵢⱼ is the distance between two atoms i and j, eᵢ and eⱼ are the respective partial charges of atoms i and j, σᵢⱼ is a constant describing the radius of the interaction, ε is a constant describing the potential energy well depth of the interaction, and kₑ is a constant. The εᵢⱼ and σᵢⱼ values are determined by applying the “mixing rules” for the atomic parameters:

εᵢⱼ=\sqrt{ε_{iε}ⱼ}and σᵢⱼ=σᵢ+σⱼ. (10)

Other similar force fields, such as CHARMM or OPLS, may also be used within the scope of this disclosure.

The total interaction energy between two molecular fragments is the sum of the pairwise energies for each of the atomic interactions. The electrostatic and Lennard-Jones potentials are implemented using the protocols for the AMBER force field. Additional “mixing” rules may be used for the non-bonded terms to avoid spurious interactions among small molecular fragments.

In an embodiment in which two types of molecular fragments, such as an ORF and water, are used, five possible interactions exist among the ORF, the water and the protein in the system. The fragment-protein and water-protein interactions are computed using the AMBER force field without modification.

The remaining interactions (ice., fragment-water, fragment-fragment and water-water interactions) do not include interaction with the protein. The fragment-water and water-water interactions are computed using the standard AMBER force field. The mixing rule is that the epsilon value for the inter-molecular interaction is zero for the r⁻⁶ term when both of the atoms in the interaction are ORFs. This permits the simulation to reproduce protein binding interactions mediated by water. Furthermore it allows water to create hydrogen bonded networks around polar protein residues that reflect the high solvation enthalpy and entropy of those regions.

When both of the atoms in the interaction are in ORFs, only the repulsive r−12 term of the Lennard-Jones potential is used. The repulsive potential prevents two fragments from physically overlapping and limits the density of fragments in the system, which would otherwise rise exponentially with the free energy. This prevents a large population of fragments from accumulating due to attractive potentials among them. Moreover, it preserves the integrity of the water hydrogen-bond network around the organic fragments by preventing the overlap. In concentration of biological interest, the fragment-fragment interactions are negligible due to the low concentrations of ligands in actual systems.

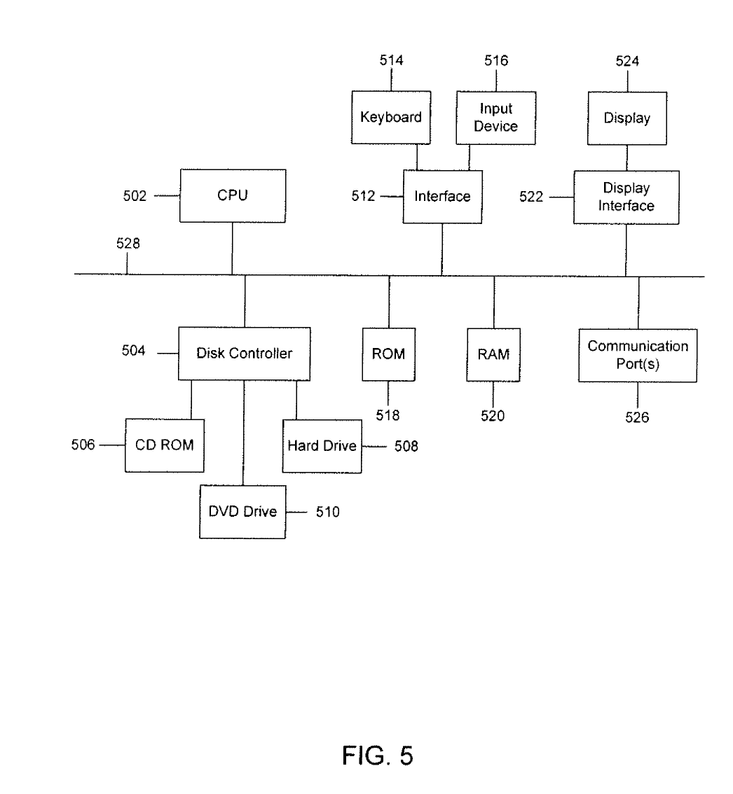

FIG. 5 is a block diagram of an exemplary system that may be used to contain or implement the program instructions according to an embodiment. Referring to FIG. 5, a bus 528 serves as the main information highway interconnecting the other illustrated components of the hardware. CPU 502 is the central processing unit of the system, performing calculations and logic operations required to execute a program. Read only memory (ROM) 518 and random access memory (RAM) 520 constitute exemplary memory devices or storage media.

A disk controller 504 interfaces with one or more optional disk drives to the system bus 528. These disk drives may include, for example, external or internal DVD drives 510, CD ROM drives 506 or hard drives 508. As indicated previously, these various disk drives and disk controllers are optional devices.

Program instructions may be stored in the ROM 518 and/or the RAM 520. Optionally, program instructions may be stored on a computer readable storage medium, such as a compact disk, a digital disk, a memory or any other tangible recording medium.

An optional display interface 522 may permit information from the bus 528 to be displayed on the display 524 in audio, graphic or alphanumeric format. Communication with external devices may occur using various communication ports 526.

In addition to the standard computer-type components, the hardware may also include an interface 512 which allows for receipt of data from input devices such as a keyboard 514 or other output device 516 such as a mouse, remote control, pointer and/or joystick.

An embedded system may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A computer-implemented method of analyzing a macromolecule for potential binding sites, the method comprising:
selecting a plurality of molecular species;
selecting a free energy value;
selecting an operation from a molecular fragment insertion operation, a molecular fragment deletion operation and a molecular fragment movement operation;
performing the selected operation on a computer representation of an instance of a molecular fragment based on a grand canonical ensemble probability density function associated with the selected operation, wherein the selected operation is performed at one of a plurality of binding sites;
determining whether to store information pertaining to the plurality of binding sites;
repeating the operation selecting, performing and determining steps a plurality of times; and
outputting a plurality of occupation probabilities based on the stored information, wherein the occupation probabilities comprise, for each molecular species, a probability that an instance of a molecular fragment of the molecular species resides at a binding site.

2. The method of claim 1 wherein the plurality of molecular species comprise an organic fragment and a water molecule.

3. The method of claim 2 wherein the organic fragment is selected from the group consisting of acetone, acetaldehyde, formamide, ammonia, benzene, acetic acid, pyrazine, methyl acetate, dimethyl ether, formaldehyde, furan, imidazole, methane, methanol, phosphoric acid, pyridine, pyrimidine, pyrrole, methanethiol, and thiophene.

4. The method of claim 1 wherein the plurality of molecular species comprise a first organic fragment and a second organic fragment.

5. The method of claim 1 wherein selecting a free energy value comprises selecting a value of B, wherein
$$B = \frac{{μ}^{′}}{kT} + ln < N > ,$$
where μ′ is an excess chemical potential, k is Boltzmann's constant, T is an absolute temperature, and <N>is a mean number of molecular fragments for a molecular species.

6. The method of claim 5 wherein:
selecting an operation comprises selecting a molecular fragment insertion operation; and
performing the selected operation comprises:
selecting a molecular species from the plurality of molecular species,
selecting a sampling site from the plurality of binding sites,
determining a change in a binding energy value based on inserting the instance of a molecular fragment of the selected molecular species at the sampling site, and
inserting the instance of the molecular fragment of the selected molecular species at the sampling site based on a probability determined by a grand canonical ensemble probability density function.

7. The method of claim 6 wherein the grand canonical ensemble probability distribution function comprises
$$\text{?} = min ( 1 , exp ( - Δ E / kT + B ) \frac{V}{N + 1} ) , \\ \text{?} \text{indicates text missing or illegible when filed}$$
wherein ΔE is the change in the binding energy value, V is a volume in which a molecular fragment can be inserted, and N is a number of instances of molecular fragments of the selected molecular species located at the plurality of sampling sites.

8. The method of claim 7 wherein the change in binding energy is computed by determining
$$E = 4 ɛ [ ( \text{?} ) - ( \text{?} ) ] + \text{?}$$
$$\text{?} \text{indicates text missing or illegible when filed}$$
before and after inserting the instance of the computer representation of the molecular fragment, wherein rᵢⱼ is a distance between two atoms i and j, eᵢ and eⱼ are respective partial charges of atoms i and j, σᵢⱼ is a constant describing the radius of an interaction, and ε is a constant describing a potential energy well depth of the interaction.

9. The method of claim 5 wherein:
selecting an operation comprises selecting a molecular fragment deletion operation; and
performing the selected operation comprises:
selecting an instance of a molecular fragment from one or more instances of molecular fragments, wherein each instance of a molecular fragment is located at a binding site,
identifying a molecular species for the selected instance of the molecular fragment,
determining a change in a binding energy value based on deleting the selected instance of the molecular fragment from a binding site corresponding to the selected instance, and
deleting the selected instance from the corresponding binding site based on a probability determined by a grand canonical ensemble probability density function.

10. The method of claim 9 wherein the grand canonical ensemble probability distribution function comprises
$$\text{?} = min ( 1 , exp ( - Δ E / kT - B ) \frac{N}{V} ) , \\ \text{?} \text{indicates text missing or illegible when filed}$$
wherein ΔE is the change in the binding energy value, V is a volume in which a molecular fragment can be inserted, and N is a number of instances of molecular fragments of the selected molecular species located at the plurality of sampling sites.

11. The method of claim 10 wherein the change in binding energy is computed by determining
$$E = 4 ɛ [ \text{?} ] + \text{?}$$
$$\text{?} \text{indicates text missing or illegible when filed}$$
before and after inserting the instance of the computer representation of the molecular fragment, wherein rᵢⱼ is a distance between two atoms i and j, eᵢ and eⱼ are respective partial charges of atoms i and j, σᵢⱼ is a constant describing the radius of an interaction, and ε is a constant describing a potential energy well depth of the interaction.

12. The method of claim 5 wherein:
selecting an operation comprises selecting a molecular fragment movement operation; and
performing the selected operation comprises:
selecting an instance of a molecular fragment from one or more instances of molecular fragments, wherein each instance of a molecular fragment is located at a binding site,
determining a change in a binding energy value based on repositioning the selected instance of the molecular fragment at a binding site corresponding to the selected instance, and
repositioning the selected instance at the corresponding binding site based on a probability determined by a grand canonical ensemble probability density function.

13. The method of claim 12 wherein the grand canonical ensemble probability distribution function comprises Pₘₒᵥₑ ^{acc}min(1, exp(−ΔE/kT)), wherein ΔE is the change in the binding energy value.

14. The method of claim 12 wherein the change in binding energy is computed by determining
$$E = 4 ɛ [ \text{?} ] + \text{?}$$
$$\text{?} \text{indicates text missing or illegible when filed}$$
before and after inserting the instance of the computer representation of the molecular fragment, wherein rᵢⱼ is a distance between two atoms i and j, e, and eⱼ are respective partial charges of atoms i and j, σᵢⱼ is a constant describing the radius of an interaction, and ε is a constant describing a potential energy well depth of the interaction.

15. The method of claim 12 wherein repositioning the selected instance of the molecular fragment comprises one or more of translating the selected instance of the molecular fragment and rotating the selected instance of the molecular fragment.

16. A system for analyzing a macromolecule for potential binding sites, the system comprising:
a processor; and
a processor-readable storage medium in communication with the processor;
wherein the processor-readable storage medium comprises one or more programming instructions for performing a method of analyzing a macromolecule for potential binding sites, the method comprising:
selecting a plurality of molecular species,
selecting a free energy value,
selecting an operation from a molecular fragment insertion operation, a molecular fragment deletion operation and a molecular fragment movement operation,
performing the selected operation on a computer representation of an instance of a molecular fragment based on a grand canonical ensemble probability density function associated with the selected operation, wherein the selected operation is performed at one of a plurality of binding sites,
determining whether to store information pertaining to the plurality of binding sites,
repeating the operation selecting, performing and determining steps a plurality of times, and
outputting a plurality of occupation probabilities based on the stored information, wherein the occupation probabilities comprise, for each molecular species, a probability that an instance of a molecular fragment of the molecular species resides at a binding site.

17. The system of claim 16 wherein the one or more programming instructions for selecting an operation comprise one or more programming instructions for selecting a molecular fragment insertion operation, and
wherein the one or more programming instructions for performing the selected operation comprise one or more programming instructions for:
selecting a molecular species from the plurality of molecular species,
selecting a sampling site from the plurality of binding sites,
determining a change in a binding energy value based on inserting the instance of a molecular fragment of the selected molecular species at the sampling site, and
inserting the instance of the molecular fragment of the selected molecular species at the sampling site based on a probability determined by a grand canonical ensemble probability density function.

18. The system of claim 16 wherein the one or more programming instructions for selecting an operation comprise one or more programming instructions for selecting a molecular fragment deletion operation, and
wherein the one or more programming instructions for performing the selected operation comprise one or more programming instructions for:
selecting an instance of a molecular fragment from one or more instances of molecular fragments, wherein each instance of a molecular fragment is located at a binding site,
identifying a molecular species for the selected instance of the molecular fragment,
determining a change in a binding energy value based on deleting the selected instance of the molecular fragment from a binding site corresponding to the selected instance, and
deleting the selected instance from the corresponding binding site based on a probability determined by a grand canonical ensemble probability density function.

19. The system of claim 16 wherein the one or more programming instructions for selecting an operation comprise one or more programming instructions for selecting a molecular fragment movement operation, and
wherein the one or more programming instructions for performing the selected operation comprise one or more programming instructions for:
selecting an instance of a molecular fragment from one or more instances of molecular fragments, wherein each instance of a molecular fragment is located at a binding site,
determining a change in a binding energy value based on repositioning the selected instance of the molecular fragment at a binding site corresponding to the selected instance, and
repositioning the selected instance at the corresponding binding site based on a probability determined by a grand canonical ensemble probability density function.

20. The system of claim 19 wherein the one or more programming instructions for repositioning the selected instance comprise one or more programming instructions for translating the selected instance.

21. The system of claim 19 wherein the one or more programming instructions for repositioning the selected instance comprise one or more programming instructions for rotating the selected instance.

22. A method of analyzing a macromolecule for potential binding sites, the method comprising:
selecting an operation from a plurality of operations;
performing the operation on a computer representation of an instance of a molecular fragment of a molecular species at a binding site with a probability based on an associated grand canonical ensemble probability density function;
repeating the selecting and performing steps a plurality of times for instances of molecular fragments of a plurality of molecular species at a plurality of binding sites: and
storing, in a storage medium, at least one occupancy probability pertaining at least to a likelihood that an instance of a molecular fragment of a molecular species resides at a binding site.
